(19) United States
(12) Patent Application Publication
(10) Pub. No.: US 2009/0206230 A1
(43) Pub. Date: Aug. 20, 2009

(54) Method and System for Repositioning a Pump Jack

(76) Inventor: Gerard Dauvin, Redvers (CA)

Correspondence Address: ADE & COMPANY INC., 2157 Henderson Highway, WINNIPEG, MB, R2G1P9, CA

(21) Appl. No.: 12/031,899

(22) Filed: Feb. 15, 2008

(51) Int. Cl. F16M 7/00; B66F 11/00; F16M 13/00; B23Q 1/00

(52) U.S. Cl. 248/651; 254/84

(57) ABSTRACT

A method and system for repositioning a pump jack installed atop a generally planar supporting surface to pump fluid from a wellbore uses at least three lift jacks arranged for movement along the supporting surface and for lifting upward relative thereto. The lift jacks are used to lift the pump jack upward from the supporting surface to be carried on the lift jacks and a force is applied to the pump jack in a predetermined direction along the supporting surface to move the lift jacks and the pump jack carried thereon along the supporting surface to a new position.

### FIELD OF THE INVENTION

This invention relates to methods and systems for moving or repositioning walking beam pump jacks used to pump fluids from wellbores.

### BACKGROUND OF THE INVENTION

Walking beam pump jacks are commonly used in the oilfield industry to effect the reciprocal drive of a polish rod extending down into a wellbore from above the wellhead in order to operate a downhole pump in order to pump fluids to the surface. A pump jack typically features a base frame anchored to the ground in proximity to the well head with the walking beam pivotally supported at an elevation above the base frame by a vertically extending support structure or Samson post extending upward therefrom. The base frame is typically mounted atop a concrete pad or slab with the base frame bolted to rails incorporated into the concrete pad to collectively define the overall base structure of the pump jack installation. During installation of the pump jack, the unit is carefully positioned to situate the head properly to establish good axial alignment of the polish rod with the production tubing in wellbore. Polish rod After this initial installation, ground shifting or settling may cause movement of the concrete pad, resulting in misalignment between the walking beam head and the wellhead, potentially causing excessive wear on packings (seals) on the polish rod, allowing gas & fluid escape from wellhead.

Conventionally, repositioning of a pump jack on a shifted base pad may rely on lifting the pump jack with a crane after unbolting the base frame of the pump jack from the mounting rails in the pad to allow shifting to a new position on the pad or alternatively shimming of one side of the pump jack frame to reestablish alignment between the walking beam head and wellhead. The cost to bring in a crane and a suitable crew for such an operation can be quite excessive, especially considering the need for a trained crane operator and transportation costs associated with bringing large scale equipment to what is often a remote site. Alternatively, hydraulic equipment, for example hydraulic jacks fastened to the hold down rails or hooked around the concrete pad may be utilized to attempt to simply push the base frame along the pad, although the tremendous force needed to perform such a dragging operation may be prohibitive when dealing with larger pump jacks.

As a result, it is desirable to provide an improved method of moving or repositioning a pump jack to establish proper alignment with the wellhead.

### SUMMARY OF THE INVENTION

According to a first aspect of the invention there is provided a method of repositioning a pump jack installed atop a generally planar supporting surface to pump fluid from a wellbore, the method comprising:

providing a frame of the pump jack with at least three downward facing lifting surfaces spread out over two dimensions along said generally planar supporting surface such that each lifting surface is elevated over a respective unoccupied portion of the supporting surface;

positioning a respective lift jack arranged for movement along the supporting surface and lifting upward relative thereto beneath each lifting surface provided on the frame of the pump jack;

using the lift jacks to lift the pump jack upward from the supporting surface to be carried on the lift jacks;

applying a force to the base of the pump jack in a predetermined direction along the supporting surface to move the lift jacks and the pump jack carried thereon along the supporting surface to a new position; and

using the lift jacks to lower the pump jack back onto the supporting surface.

The step of providing the pump jack frame with the lifting surfaces may comprise connecting lifting members thereto at spaced positions therealong to define the lifting surfaces.

Preferably the lifting members comprise elongate lifting beams are connected to the frame of the pump jack to each extend thereacross.

Preferably at least two of the lifting surfaces are defined laterally outward from the pump jack frame.

Preferably the lifting members are releasably connected to the pump jack frame.

Preferably each lifting beam extends laterally outward from the pump jack frame to situate the lifting beam's ends outward therefrom, each lifting beam being releasably connected to the pump jack frame by a respective pair of hangers, the hangers each fitted onto the lifting beam proximate a respective end thereof to engage the pump jack frame at sides thereof and hang the pump jack frame from the lifting beams under lifting thereof by the lift jacks.

Preferably each hanger comprises a beam engaging portion extended about a top surface of the beam to hang therefrom and a frame engaging portion extending from the beam engaging portion toward a transverse center of the pump jack frame to pull upward against a lip of the pump jack frame projecting transversely outward therefrom.

Preferably the pump jack frame comprises a pair of frame beams across which the lifting beams are extended, each lip pulled by the hangers being defined by upper flanges of the frame beams.

Preferably the beam engaging portion of each hanger comprises a component of an inverted-U shape extending about the top surface of the beam and downward on each side thereof to support the frame engaging portion below the beam.

Preferably the frame engaging portion of each hanger has inner and outer ends on opposite sides of the beam engaging portion, the outer end contacting a bottom surface of the lifting beam and the inner end contacting the lip of the pump jack frame during lifting of the beam.

The frame engaging portion of each hanger may be pivotally connected to the beam engaging portion for pivoting about an axis extending across the frame engaging portion between the inner and outer ends thereof.

Preferably each lift jack is disposed atop a slider having an upper surface arranged for sliding motion along the supporting surface.

Preferably the slider comprises a stationary base placed on the respective unoccupied portion of the supporting surface and a movable member slidably supported on the stationary base for limited sliding therealong.

Preferably the slider comprises roller elements disposed between the stationary base and the movable member.

Preferably the stationary base defines stops limiting the sliding motion of the movable member.

The movable member is substantially limited to sliding relative to the stationary base along a single direction, the step of positioning the respective lift jacks beneath the lifting surfaces comprising aligning the sliders in the predetermined direction along the supporting surface in which the pump jack is to be moved.

According to a second aspect of the invention there is provided a system for repositioning a pump jack installed atop a generally planar supporting surface to pump fluid from a wellbore, the system comprising:

at least three lift jacks;

at least three sliders each arranged to support a respective one of the lift jacks atop a movable member of the slider, each slider comprising a stationary base on which the movable member is slidably supported for limited sliding therealong; and

a forcing mechanism connectable to the pump jack to apply force thereto in a predetermined direction;

whereby the pump jack can be repositioned along the support surface by operating the lift jacks to lift the pump jack from the supporting surface for carrying on the moveable members of the sliders and then operating the forcing mechanism to move the pump jack along the supporting surface by sliding of the pump jack with the movable members of the sliders.

There may be provided lifting members arranged to connect to the pump jack to define downward facing lifting surfaces thereon at an elevation above the lifting surface to facilitate lifting of the pump jack by use of the lift jacks on the lifting members at the lifting surfaces defined thereby. In this instance, preferably there are provided hangers arranged to connect to the lifting members to depend downward therefrom and engage with the pump jack below the lifting members to effect hanging of the pump jack from the lifting members during lifting thereof by the lift jacks.

Preferably the forcing mechanism is arranged for connection between the pump jack and an anchor point at a fixed position relative to the supporting surface.

### BRIEF DESCRIPTION OF THE DRAWINGS

In the accompanying drawings, which illustrate an exemplary embodiment of the present invention:

FIG. 1 is a schematic side elevational view of a pump jack repositioning system installed on the frame of a pump jack.

FIG. 2 is a schematic end elevational view of the system of FIG. 1 installed on the frame of the pump jack, the rest of the pump jack being omitted for ease of illustration.

FIG. 3 is a schematic cross sectional view of a slider of the system of FIG. 1 as taken along line A-A thereof.

FIG. 4 is a schematic cross sectional view of the slider of FIG. 3 as taken along line B-B thereof with a movable member of the slider in a center position.

FIG. 5 is a schematic cross sectional view of the slider, similar to FIG. 4 but with the movable member of the slider in an end position.

FIG. 6 is a schematic end elevational view of a hanger of the system of FIG. 1.

FIG. 7 is a schematic side elevational view of the hanger of FIG. 6.

FIG. 8 is an overhead plan view of the hanger of FIG. 6.

### DETAILED DESCRIPTION

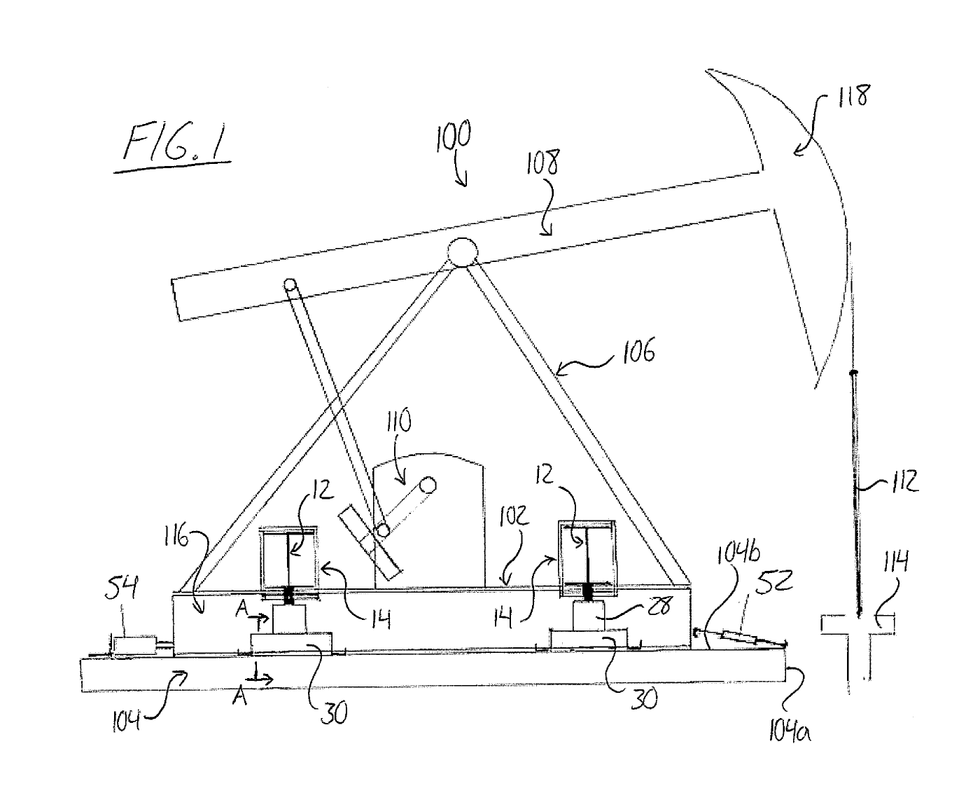

FIG. 1 schematically shows a conventional pump jack 100 having a base frame 102 sitting atop a concrete pad 104 to support a vertically extending tower 106 having a walking beam 108 pivotally mounted theretop, to which a drive system 110 is connected in a conventional manner to effect a nodding type motion thereof in order to drive reciprocating motion of a polish rod 112 through a wellhead 114 positioned just past a respective end 104a of the concrete pad 104. The frame 102 includes a pair of parallel I-beam frame members 116 spaced apart from one another and extending in a longitudinal direction of the pump jack 100 and concrete pad 104 parallel to the plane in which the walking beam pivots to effect the nodding motion of the head 118 thereof.

FIGS. 1 and 2 schematically illustrate a system useful in accordance with an embodiment of the invention to effect movement of the pump jack 100 along the top surface 104b of the concrete pad 104 atop which the pump jack sits, for example to reposition the pump jack 100 to realign the walking beam head 118 with the wellhead 114 after shifting or settling of the concrete pad 104 from its original position. The system includes a pair of I-beam lifting members 12 that are laid in a parallel fashion in a transverse direction relative to the pump jack 100 proximate opposite ends thereof, thus extending across the two frame members 116 to project laterally outward past each one thereof so that each end 12a of each lifting member 12 is situated on a side of a respective one of the frame members 116 opposite a vertically oriented center-plane of the pump jack extending parallel to the frame members 116 half way between them. A bottom flange 12b of each I-beam lifting member 12 rests atop the frame members 116, the downward facing surface of the bottom flange 12b defining two lifting surfaces adjacent the ends 12a of the lifting member 12 by which the pump jack 100 will be lifted as described herein further below.

After laying the lifting members 12 across the frame members 116, a hanger 14 is slid over each end 12a of the lifting members toward the frame members 116. Referring to FIGS. 1, 2 and 6 to 8, each hanger 14 has an upper portion 16 for engaging the lifting member 12 and a lower portion 20 for engaging the frame member 116 adjacent the respective end 12a of the lifting member. The upper portion 16 of the hanger 14 has a squared off inverted-U shape having a rigid center section 16a of suitable length to span across the upper flange 12c of the I-beam lifting member 12 and parallel rigid side leg sections 16b of equal length to one another extending downward from opposite ends of the center section 16 sufficiently far to reach down below the lifting member 12 with the center section 16 situated atop the upper flange 12c thereof. Positioned this way to extend about the upper flange 12c of the lifting member 12, the upper portion 16 of the hanger defines the hook end of the hanger by which it hangs from the lifting member 12. At its bottom end, the upper portion 16 has its inverted-U shape closed off by a rigid pivot shaft 18 extending between the two side leg sections 16b to give the upper portion an overall closed-rectangular shape. Here a lower portion 20 of the hanger 14 is connected to the upper portion 16 thereof and arranged to engage with the frame members 116 of the pump jack 100.

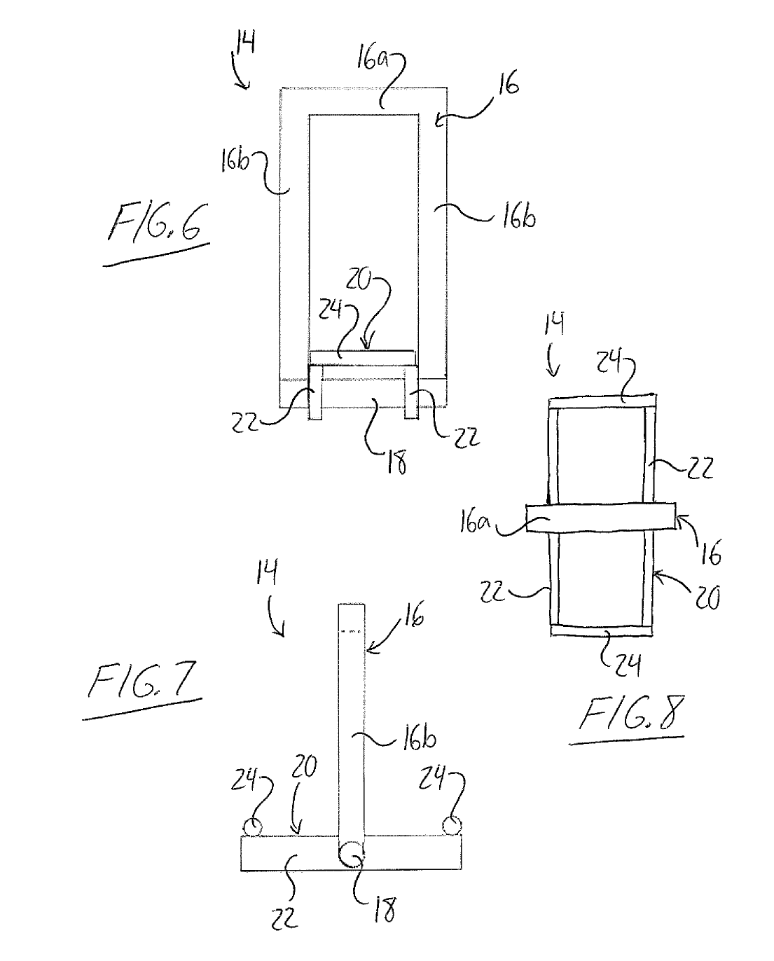

The pivot shaft 18 passes perpendicularly through two parallel rigid arms 22 of the lower portion 20 of the hanger 14, the equally dimensioned arms 22 being rigidly interconnected at each end thereof by rigid cross-members 24 extended perpendicularly between them to form a closed rectangle. With the lower portion 20 of the hanger oriented about the pivotal axis defined by the pivot shaft 18 to take on a position perpendicular to the upper portion 16, as shown in FIG. 7, the spacing between each cross member 24 and the central section 16a of the upper section 16 parallel thereto is sufficient to allow passage of the frame member 12 axially or lengthwise through the opening between the side leg sections 16b. As shown in FIG. 2, with the elongate lifting members 12 laid across the elongate frame members 116 and the hangers 14 fitted over the ends 12a of the lifting members and slid therealong to reach the frame members 116, the one of the cross members 24 at an inner end of the lower portion 20 of each hanger 14 nearest the center plane of the pump jack 100 extends theretoward beneath the upper flange 116a of the respective I-beam frame member 116, the same upper flange 116a blocking further sliding of the hanger's lower portion 20 inward along the lifting member 12. When the lifting members 12 are subsequently lifted, as described herein below, with the upper portion 16 of each the hanger 14 extending about the upper flange 12c of the lifting member, the one of the cross members 24 at this inner end of each hanger's lower portion 20 will lift up against the bottom surface of the frame member's upper flange 116a and the cross member at the opposite outer end of the hanger's lower portion 20 will lift up against the bottom surface of the lifting member's bottom flange 12b laterally outward from the frame member 116. The frame members 116 will thus be lifted with and carried by the lifting members by the temporary connection established therebetween by the removable hangers 14.

With the lifting members 12 laid across the frame members 116 with the hangers slid over their ends 12a to project laterally inward toward the center of the frame below a lip, ledge or shoulder of the frame defined by the upper flanges 116a of the frame members on the laterally outward sides thereof, a lifting mechanism 26 is positioned to sit directly atop the upper supporting surface 104b on unoccupied portions thereof disposed directly below the downward facing lifting surfaces defined by the bottom surface of the lower flange 12b of a respective one of the lifting members 12 adjacent a respective end 12a thereof. This positioning of lifting mechanisms 26 in these previously unoccupied spaces defined between the concrete pad 104 and the lifting members 12 laterally outward from the frame members 116 facilitates lifting of the pump jack 100 by raising a lift jack 28 of each lifting mechanism 26 to engage against the bottom of the lifting members 12 and continuing to raise the lift jacks 28 to elevate the lift members 12 so that the frame members 116, and the rest of the pump jack 100 mounted thereon, are lifted off the concrete pad 104 as a result of being hung from the rising lifting members 12 by the hangers 14.

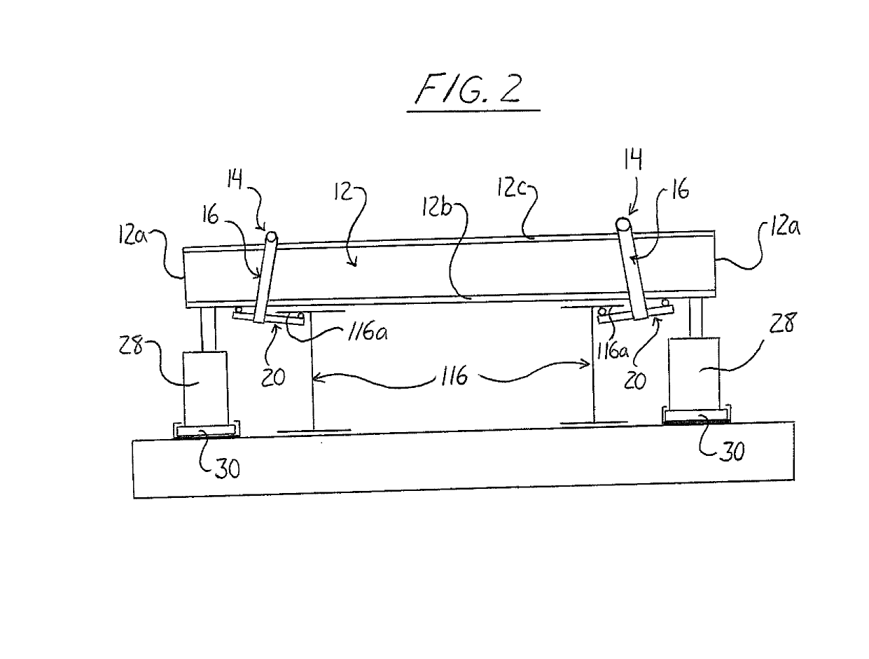

With the pump jack 100 so lifted, it can then be moved or shifted along the upper surface 104b of the concrete pad 104 to reposition the pumpjack thereon. To facilitate this movement along a plane generally parallel to the top surface 104b of the pad 104, each lifting mechanism 26 features a slider device 30 atop which the respective lift jack 26 is supported. With reference to FIGS. 3 to 5, the slider device 30 features a stationary base or housing 32 having a main panel 34 that sits flat atop the support surface 104b of the concrete pad 104 in a stationary position thereon. As shown in FIG. 3, side walls 36 project perpendicularly upward from the main panel 34 at opposite sides thereof, each having a respective lateral flange 38 projecting perpendicularly from the side walls at top ends thereof opposite the main panel 34 in an inward direction back over the main panel 34 a short distance toward the center thereof. Atop the main panel 34 of the stationary base, between the side walls 36 and below the lateral flanges 38, sits a plurality of balls 40 housed within a planar ball cage 42 parallel to the main panel 34. A movable member 44 featuring a supporting panel 46 parallel to the main panel 34 of the stationary base 32 sits atop the balls 40 beneath the lateral flanges 38 so as to be slidable along the main panel 34 of the stationary base 32 and the top surface 104b of the concrete pad on which it sits. The lift jack 28 sits atop the support panel 46 of the movable member 44 so that the lift jack 28, and the lifting members 12 and pump jack 100 carried thereon when the lift jacks are raised, are slidable with the movable member 44 along the concrete pad.

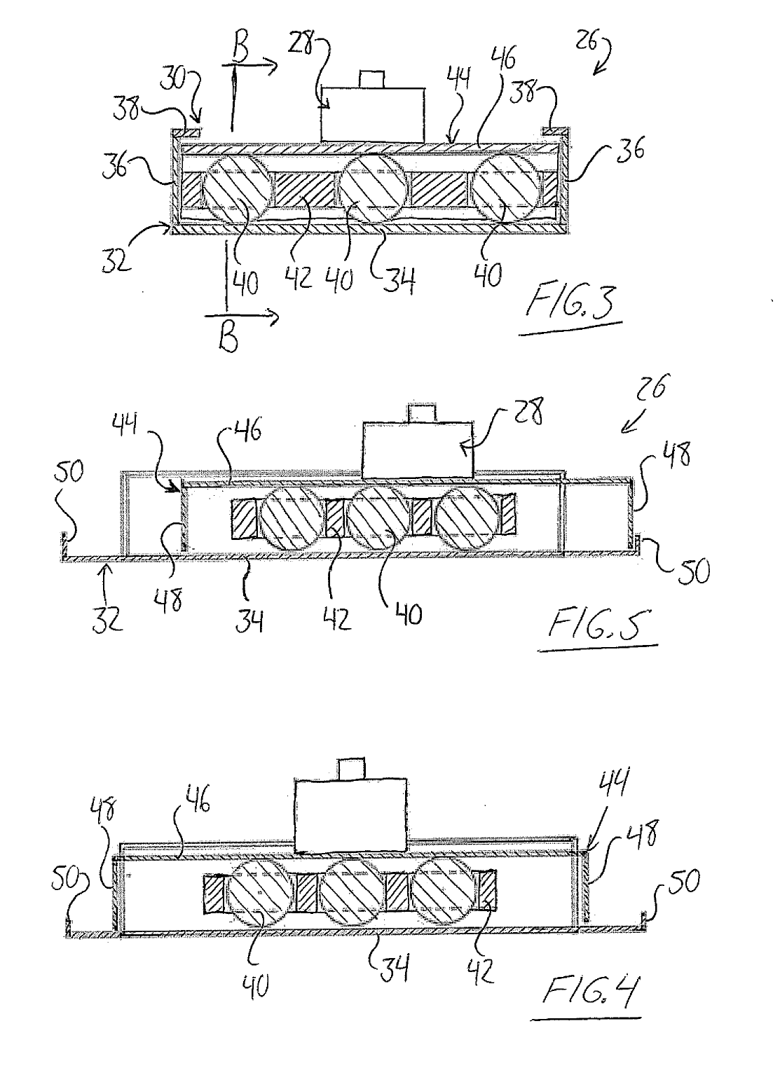

In the illustrated embodiment, the ball cage 42 and the supporting panel 44 extend substantially the full interior width of the slider's stationary base 32 between the side walls 36 thereof, leaving sufficient clearance to allow free sliding of the balls 40 in the longitudinal direction of the slider parallel to the side walls 36 thereof, but preventing any significant sliding in the transverse direction. The sliders of the illustrated embodiment are thus each unidirectional, generally allowing sliding of its movable member 44 along only a single direction. As shown in FIG. 5, sliding of the movable member 44 toward either end of the slider along this single direction is limited by cooperating stops defined on the movable member 44 and the stationary base 32. At opposite ends of the support panel 46, vertical flanges 48 project perpendicularly downward therefrom between the side walls 36 of the stationary base 32. Corresponding vertical flanges 50 project perpendicularly upward across the main panel 34 of the stationary base 32 at the opposite ends thereof so that lower ends of the movable member vertical flanges 48 are situated between the stationary base vertical flanges 50 and below the upper ends thereof. As shown in FIGS. 4 and 5, the movable member vertical flanges 48 extend downward form the support panel 46 nearly fully to the main panel 34 of the stationary base 32 to keep the ball cage 42 beneath the support panel 46 without contacting the main panel 34. The stationary base vertical flanges 50 are spaced further apart than the movable member vertical flanges 48 to allow the sliding of the movable member 44 therebetween. FIG. 4 shows the movable member in a center position centered between the stationary base vertical flanges 50, with FIG. 5 showing the movable member having been slid from the center position into one of two end positions in which one of the movable member vertical flanges 48 contacts a respective one of the stationary base vertical flanges 50. The vertical flanges thus define stops limiting the sliding movement of the movable member relative to the stationary base and preventing separation thereof.

To use the system, the sliders 26 are each placed below a respective one of the lifting surfaces defined by the lifting members 12 adjacent their ends 12a with the lift jacks 28 supported on the movable members of the sliders. Before jacking up the pump jack frame 102, the direction in which the pump jack needs to be shifted along the concrete pad is determined, for example based on where the pump jack 100 needs to be repositioned to realign with walking beam head with the well head. In the illustrate embodiment where the sliders 26 are unidirectional, care must be taken to align the slider's into parallel orientations having their longitudinal sliding axes extending along this predetermined direction. The lift jacks 28 are then raised to lift the lifting member beams 12 and the pump jack frame member beams 116 connected thereto by the hangers 14 and the pump jack 100 is then slid along the concrete slab 104 in the predetermined direction by movement on the movable members of the sliders to move the pump jack into the new desirable position.

As shown in FIG. 1, the actual movement of the pump jack 100 once lifted from the pad 104 for support on the moveable members of the sliders is effected by a forcing mechanism, such as a hydraulic puller 52 or hydraulic cylinder pusher 54, connected between the pump jack frame 102, for example perpendicular thereto at an end or side thereof, and an anchoring point in a fixed position relative to the concrete pad 104 to exert a linear force on the pump jack frame 102 to move it in the predetermined direction. As shown, a hydraulic puller 52 may be connected at one end to the pump jack frame 102 and anchored at the other end to an edge of the concrete pad 104, for example at end 104a thereof. Alternatively, a pushing hydraulic cylinder may be positioned between a rigid stop 56 fixed to the concrete pad to extend upward from the top surface 104a thereof and a generally vertical surface on the pump jack frame 102 to push the pump jack in the predetermined direction on the sliders 26. Alternatively, a manually operable come-along may be connected between the pump jack frame 102 and a fixed anchoring point to pull the pump jack. It will be appreciated that other equipment may be similarly used to pull or tow the pump jack once lifted off the concrete pad 104 by the lift jacks 28 for support by the sliders 28.

Once the pump jack has been shifted to the desired position, the lift jacks are lowered to bring the pump jack frame 102 down back onto the concrete pad 104 and take the weight of the pump jack off the sliders. The sliders 30 and lift jacks 28 are removed from beneath the lifting members 12, the hangers 14 are slid off the ends of thereof and the lifting members are removed from atop the pump jack frame 102, leaving the pump jack in its original unmodified condition, but in a new position on the concrete pad, for example in newfound proper alignment with the wellhead 114. It will be appreciated that the distance by which the pump jack can be moved in the predetermined direction using the above-described embodiment is limited by the maximum allowable distance the moveable members of the sliders can be displaced along their stationary bases, reflecting the relatively short distances typically needing to be covered when repositioning a pump jack on a shifted concrete pad to reestablish alignment with the wellhead. Larger distances may be covered by multiple lifting and lowering of the pump jack with shifting of the sliders therebetween, the sliders of course not being intended to move the pump jack over large distances but merely to allow repositioning thereof on the existing base pad or slab.

A prototype of the above-described system has been developed with the hangers having the lower portion 20 rigidly, not pivotally, connected to the upper portion 20 at an orientation perpendicular thereto with the shaft 18 instead extending across and fixed atop the arm members 22 of the lower portion 20, rigidly connected between the legs 16 of the upper portion above their lower ends. This rigid non-pivotal arrangement may use shimming material inserted between the inner end of the lower portion and the frame member 116 upper flange 116a and between the center section 16a of the upper portion and the top flange 12c of the lifting beam 12 to ensure secure hanging of the pump jack frame from the lifting members. The prototype hanger is formed of welded-together round metal stock, with the three sections of the inverted-U shaped portion being doubled up and each arm of the lower portion formed of round stock reinforced with thick metal plate extending therealong and projecting downward therefrom below the legs of the inverted-U. The prototype sliders do not have the flange-defined stops defined herein above for the illustrated embodiment, as their iron plate main panels do not extend outward past the ends of the sidewalls 36 as in the embodiment of FIGS. 4 and 5. Instead, a piece of rectangular tubing is welded to the main panel to project outward therefrom in the longitudinal direction at each end thereof, with a bolt fixed to the rectuangular tubing to project upward therefrom and define a stop against which a respective end edge of the support panel 44 comes into contact under sufficient sliding out of the center position. The vertical moveable member flanges 48 are replaced with obliquely extending panels mounted in their place extending downward and outward from the iron plate support panel 46 and having rectangularly notched portions in the center of their bottom edges to accommodate sliding of the support panel over the rectangular tubing. To support the significant weight of a pump jack, the lifting mechanisms of the prototype uses four twenty-ton bottle jacks with nine balls from the main swing bearing of an excavator in each slider.

It will be appreciated that the system may be provided in many different forms. The sliders and lift jacks may be separate units as in the illustrated embodiment, or fixed together or incorporated into a single lifting mechanism. A pump jack frame having existing downward facing surfaces displaced over empty space at unoccupied portions of the surface on which the pump jack frame is supported may be able to use these surfaces as the lifting surfaces at which the lift jacks operate, thereby eliminating the need to connect separate lifting members to the frame. Where lifting members are required, they may be connected to the frame other than by the hangers described for the illustrated embodiment. For example, lifting members may be rigidly and permanently fixed to the pump jack frame, allowing for future repositioning thereof without needing to repeat the step of connecting detachable lifting members, or other connection mechanisms may be used in place of the illustrated hangers to accommodate other shapes or styles of pump jack frames. Use of detachable lifting members 12 has the advantage of allowing the same kit or system to be used on multiple pump jacks without the need to replace any components of the system. It will be appreciated that the lifting and frame members are not limited to the I-beam structures utilized in the illustrated embodiments.

Although the illustrated embodiment features four lifting mechanisms, each positioned laterally outward from the pad-contacting frame members 116, it will be appreciated that it may be possible to use as few as three lifting mechanisms, for example two positioned on opposite sides of the pump jack frame outward therefrom proximate one end thereof with a third positioned between the frame members 116 proximate an opposite end. Of course, more than four lifting mechanisms may be used at a respective number of lifting surfaces provided on the pump jack frame. It will also be appreciated that embodiments of the slider described herein above may make use of bearing arrangements other than the ball-bearing type arrangement shown, in which spherical balls define the roller elements facilitating the sliding motion of the movable members. For example, cylindrical roller elements may be similarly applied in an appropriately shaped roller element cage. It is also conceivable that the movable members on which the lift jacks are supported for a sliding or rolling like motion over the upper support surface of the pad may be defined by wheeled members of suitable strength to support the pump jack and rollable on the pad itself. The described sliders however, provide a strong low-profile movable support structure that fits nicely with the lifting jacks within the height profile of the frame members 116 for operation between the concrete pad 104 and the lifting members 12 installed atop the frame 102 and limit motion of their movable members along the pad to improve control over the movement of the pump jack while elevated.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of repositioning a pump jack installed atop a generally planar supporting surface to pump fluid from a wellbore, the method comprising:
providing a frame of the pump jack with at least three downward facing lifting surfaces spread out over two dimensions along said generally planar supporting surface such that each lifting surface is elevated over a respective unoccupied portion of the supporting surface;
positioning a respective lift jack arranged for movement along the supporting surface and for lifting upward relative thereto beneath each lifting surface provided on the frame of the pump jack;
using the lift jacks to lift the pump jack upward from the supporting surface to be carried on the lift jacks;
applying a force to the base of the pump jack in a predetermined direction along the supporting surface to move the lift jacks and the pump jack carried thereon along the supporting surface to a new position; and
and using the lift jacks to lower the pump jack back onto the supporting surface.

2. The method according to claim 1 wherein the step of providing the pump jack frame with the lifting surfaces comprises connecting lifting members thereto at spaced positions therealong to define the lifting surfaces.

3. The method according to claim 2 wherein the lifting members comprise elongate lifting beams are connected to the frame of the pump jack to each extend thereacross.

4. The method according to claim 2 wherein at least two of the lifting surfaces are defined laterally outward from the pump jack frame.

5. The method according to claim 2 wherein the lifting members are releasably connected to the pump jack frame.

6. The method according to claim 3 wherein each lifting beam extends laterally outward from the pump jack frame to situate the lifting beam's ends outward therefrom, each lifting beam being releasably connected to the pump jack frame by a respective pair of hangers, the hangers each fitted onto the lifting beam proximate a respective end thereof to engage the pump jack frame at sides thereof and hang the pump jack frame from the lifting beams under lifting thereof by the lift jacks.

7. The method according to claim 6 wherein each hanger comprises a beam engaging portion extended about a top surface of the beam to hang therefrom and a frame engaging portion extending from the beam engaging portion toward a transverse center of the pump jack frame to pull upward against a lip of the pump jack frame projecting transversely outward therefrom.

8. The method according to claim 7 wherein the pump jack frame comprises a pair of frame beams across which the lifting beams are extended, each lip pulled by the hangers being defined by upper flanges of the frame beams.

9. The method according to claim 7 wherein the beam engaging portion of each hanger comprises a component of an inverted-U shape extending about the top surface of the beam and downward on each side thereof to support the frame engaging portion below the beam.

10. The method according to claim 7 wherein the frame engaging portion of each hanger has inner and outer ends on opposite sides of the beam engaging portion, the outer end contacting a bottom surface of the lifting beam and the inner end contacting the lip of the pump jack frame during lifting of the beam.

11. The method according to claim 10 wherein the frame engaging portion of each hanger is pivotally connected to the beam engaging portion for pivoting about an axis extending across the frame engaging portion between the inner and outer ends thereof.

12. The method according to claim 1 wherein each lift jack is disposed atop a slider having an upper surface arranged for sliding motion along the supporting surface.

13. The method according to claim 12 wherein the slider comprises a stationary base placed on the respective unoccupied portion of the supporting surface and a movable member slidably supported on the stationary base for limited sliding therealong.

14. The method according to claim 13 wherein the slider comprises roller elements disposed between the stationary base and the movable member.

15. The method according to claim 12 wherein the stationary base defines stops limiting the sliding motion of the movable member.

16. The method according to claim 12 wherein the movable member is substantially limited to sliding relative to the stationary base along a single direction, the step of positioning the respective lift jacks beneath the lifting surfaces comprising aligning the sliders in the predetermined direction along the supporting surface in which the pump jack is to be moved.

17. A system for repositioning a pump jack installed atop a generally planar supporting surface to pump fluid from a wellbore, the system comprising:
at least three lift jacks;
at least three sliders each arranged to support a respective one of the lift jacks atop a movable member of the slider, each slider comprising a stationary base on which the movable member is slidably supported for limited sliding therealong; and
a forcing mechanism connectable to the pump jack to apply force thereto in a predetermined direction;
whereby the pump jack can be repositioned along the support surface by operating the lift jacks to lift the pump jack from the supporting surface for carrying on the moveable members of the sliders and then operating the forcing mechanism to move the pump jack along the supporting surface by sliding of the pump jack with the movable members of the sliders.

18. The system according to claim 17 further comprising lifting members arranged to connect to the pump jack to define downward facing lifting surfaces thereon at an elevation above the lifting surface to facilitate lifting of the pump jack by use of the lift jacks on the lifting members at the lifting surfaces defined thereby.

19. The system according to claim 18 further comprising hangers arranged to connect to the lifting members to depend downward therefrom and engage with the pump jack below the lifting members to effect hanging of the pump jack from the lifting members during lifting thereof by the lift jacks.

20. The system according to claim 17 wherein the forcing mechanism is arranged for connection between the pump jack and an anchor point at a fixed position relative to the supporting surface.
